(19) United States
(12) Patent Application Publication
(10) Pub. No.: US 2011/0232632 A1
(43) Pub. Date: Sep. 29, 2011

(54) ENERGY CONVERSION SYSTEM

(76) Inventor: Michael David Duke, Hamilton (NZ)

(21) Appl. No.: 13/124,422

(22) PCT Filed: Oct. 16, 2009
(86) PCT No.: PCT/NZ2009/000225

§ 371 Date: Jun. 8, 2011

(30) Foreign Application Priority Data
Oct. 17, 2008 (NZ) 572115

(51) Int. Cl. E04D 13/18; B23P 15/26

(52) U.S. Cl. 126/621; 29/890.033

(57) ABSTRACT

An energy conversion device includes a roofing material having a covered channel through which fluid can flow, the channel configured such that a ratio of the cross sectional area of the channel to the length of a perimeter of the cross section of the channel is less than 8 mm.

### TECHNICAL FIELD

This invention relates to an energy conversion device. In particular it relates to a solar thermal collector.

### BACKGROUND ART

A solar thermal collector is typically a simple device which uses radiation from the sun to heat a fluid which is subsequently passed through a heat exchanger to remove heat from the fluid. The recovered heat can be used in many ways, such as heating water in a domestic water supply, as are well known in the art.

The central component of a solar heating system is the collector. A flat plate solar collector, the most common type, is made up of a selectively layered absorber that absorbs the incoming solar radiation and transforms it into heat. This absorber is commonly embedded in a thermally insulated box with a transparent cover to minimise thermal loss through convection. A heat conducting fluid (usually a mixture of water and non-environmentally damaging antifreeze) flows through the absorber and circulates between the collector and the heat exchanger or warm water storage tank. Solar thermal systems can achieve efficiencies in excess of 75%.

There are, however, a number of disadvantages currently experienced with application of solar thermal collectors.

Solar thermal collectors typically require pipes or channels in the absorber to contain the heat conducting fluid. If pipes are used these generally need to be bonded to the absorber to provide good thermal transfer from the absorber to the fluid. This adds to the time and cost of forming a collector, and may also be a limiting factor (due to the potential failure of the bonding of the pipes) on the efficiency and lifetime of a collector.

Alternatively, forming channels in the absorber requires additional machining (e.g. drilling out a channel) or in some cases forming the absorber in parts which are subsequently assembled such that a channel is formed between the parts. This also requires additional machining and assembly, thus adding to the cost of forming a collector.

Solar thermal collectors tend to have large collectors in order to capture and provide a useful amount of heat. Their size and weight means they assume the nature of a significant building structure in their own right.

In a typical installation on a roof of a building, the solar thermal collector is mounted in a frame including structural members to support the weight of the collector and to provide structural connection to the roof and to the building. Installation is relatively expensive as it requires the erection of a framework and its attachment to the building, and the appropriate connections for the fluid circuit. This can add to the expense of the installation and can also create delays as a number of people may be needed after the collector is mounted on the roof to provide the range of skills (carpentry, plumbing etc) required to complete the installation.

Furthermore the installation of the solar thermal collector typically requires some modification to the roof, including joins, to accommodate attachment of the support frame and connection of the fluid circuit. These modifications increase the likelihood of subsequent failure of joins, leading to leakage through the roof.

The added weight of the solar thermal collector (and support structure) may also give rise to engineering concerns regarding the ability of the structure to support the device. This applies particularly to the common situation where the solar thermal collector is retrofitted to an existing building.

Generally speaking, the addition of solar thermal collectors to an existing roof line may also result in an unsightly appearance.

In recent times there is a growing awareness of the need to make use of renewable energy sources and techniques. In some parts of the world, local authorities are requiring a level of energy self sufficiency for all new buildings or renovations of buildings within their jurisdiction. Use of solar thermal panels in a manner that overcomes the above disadvantages is therefore a matter of considerable interest.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided an energy conversion device including:

a roofing material;

characterised in that

the roofing material includes a covered channel through which fluid can flow, the channel configured such that a ratio of the cross sectional area of the channel to the length of a perimeter of the cross section of the channel is less than 8 mm.

According to another aspect of the present invention there is provided an energy conversion device including:

a roofing material configured to accept a panel;

at least one panel configured to include at least one covered channel through which fluid can flow; wherein the panel is bonded directly or indirectly to the roofing material

characterised in that

the covered channel is configured such that a ratio of the cross sectional area of the covered channel to the length of a perimeter of the cross section of the covered channel is less than 8 mm.

According to another aspect of the present invention there is provided an energy conversion device which includes

a roofing material

characterised in that

the roofing material includes a covered channel through which fluid can flow wherein a width of the channel is substantially greater than a depth.

According to another aspect of the present invention there is provided an energy conversion device including:

a roofing material configured to accept a panel;

at least one panel configured to include at least one open channel;

wherein the panel is bonded directly or indirectly to the roofing material so as to form a covered channel through which fluid can flow,

characterised in that

the covered channel is configured such that a ratio of the cross sectional area of the covered channel to the length of a perimeter of the cross section of the covered channel is less than 8 mm.

According to another aspect of the present invention there is provided an energy conversion device which includes:

a roofing material; and

at least one panel configured to include at least one open channel;

wherein the panel is bonded directly or indirectly to the roofing material so as to form a covered channel through which fluid can flow,

characterised in that

the panel is configured such that a width of the channel is substantially greater than a depth.

According to another aspect of the present invention there is provided an energy conversion device which includes

a roofing material having one or more open channels and

at least one panel

wherein the panel is bonded directly or indirectly to the roofing material so as to form a covered channel through which fluid can flow

characterised in that

the covered channel is configured such that a ratio of the cross sectional area of the covered channel to the length of a perimeter of the cross section of the covered

According to another aspect of the present invention there is provided an energy conversion device which includes

a roofing material having one or more open channels and

at least one panel

wherein the panel is bonded directly or indirectly to the roofing material so as to form a covered channel through which fluid can flow

characterised in that

the longest length of the channel cross-section is closest to the panel.

channel is less than 8 mm.

According to another aspect of the present invention there is provided an energy conversion device substantially as described above wherein the hydraulic diameter of the channel has a value less than 20 mm.

According to another aspect of the present invention there is provided a method of construction of an energy conversion device including

a roofing material and

at least one panel configured to include one or more open channels wherein the width of the open channel is substantially greater than the depth,

characterised by the step of

bonding the panel directly or indirectly onto the roofing material so as to form a covered channel through which fluid can flow.

A method of construction of an energy conversion device including a roofing material

characterised by the step of
a) forming a covered channel in the roofing material,

wherein a ratio of the cross sectional area of the covered channel to the length of a perimeter of the cross section of the covered channel is less than 8 mm.

According to another aspect of the present invention there is provided a method of construction of an energy conversion device including

a roofing material having one or more open channels wherein the width of the open channel is substantially greater than the depth and

at least one panel,

characterised by the step of

bonding the panel directly or indirectly onto the roofing material so as to form a covered channel through which fluid can flow.

According to another aspect of the present invention there is provided a method of construction of an energy conversion device including a roofing material configured to accept a panel; and at least one panel configured to include a covered channel, wherein a ratio of the cross sectional area of the covered channel to the length of a perimeter of the cross section of the covered channel is less than 8 mm,

the method characterised by the step of

bonding the panel directly or indirectly onto the roofing material.

According to another aspect of the present invention there is provided a method of construction of an energy conversion device including a roofing material configured to accept a panel; and at least one panel configured to include an open channel,

the method characterised by the step of

bonding the panel directly or indirectly onto the roofing material to form a covered channel wherein a ratio of the cross sectional area of the covered channel to the length of a perimeter of the cross section of the covered channel is less than 8 mm.

The energy conversion device is configured to capture energy from the sun and convert it into useable heat. An energy conversion device of the present invention is commonly referred to as a solar thermal collector.

In use heat is removed from the solar thermal collector by heat transfer liquid flowing through the covered channels formed in the roofing material.

Reference to a covered channel throughout this specification should be understood to refer to a watertight space which is enclosed apart from openings to allow fluid to enter or exit the channel.

In a typical arrangement the heat transfer fluid is in a closed circuit which includes connections to and from the covered channels of the solar thermal connector to a heat exchanger which removes heat from the fluid and returns cooler fluid to the circuit. The circuit may typically include a pump to aid circulation of the heat transfer fluid.

One object of the present invention is to provide an energy conversion device which can be integrated into a structure, and in particular into the roof of a structure. For such uses there may be a clear advantage in using a roofing product in the present invention as this may assist integration of the energy conversion device into the building

In a preferred embodiment the roofing material is a standard roofing product. A standard roofing product is to be understood as a roofing product which, in its overall configuration, closely resembles a roofing product (or some part of it) commonly used in the construction industry. Clearly the roofing material of the present invention may include additional features such as one or more additional channels etc., however, it is envisaged that the additional features will be added to a commonly used roofing material in such a way that the overall shape (width, length and configuration of major ridges etc) of the roofing material remains unchanged.

Choosing a commonly used roofing product ensures that the basis of the energy conversion device is well known within the construction industry and accepted by it as a preferred method of forming a roof. As a consequence uptake of the present invention may be rapid, as it will be seen as an enhancement of existing technology rather than an entirely new system.

Furthermore, the engineering design issues and the skills required to install the roofing material are already well known within the industry. Therefore the roofing material, as modified to form the energy conversion device, may be readily incorporated into the design of a structure and installed by anyone skilled in the art of using the roofing material.

Roofing materials, in the form of products, are generally mass produced which may provide a more cost effective material to use when forming the energy conversion device of the present invention.

Reference will be made throughout this specification to an energy conversion device including roofing material in which one intended application is integration of the energy conversion device into the roof of a structure. However, those skilled in the art will appreciate that the energy conversion device of the present invention may be used in many ways other than as part of a roofing system, for example some embodiments may be used as a stand alone unit, and that reference to the energy conversion device as part of a building integrated roofing system only throughout the specification should not be seen as limiting

In a preferred embodiment the roofing material is a long run metal panel. This provides an extended surface on which the energy conversion device may be formed.

Each energy conversion device must be connected to a fluid flow circuit. Plumbing is generally expensive to install and maintain. Therefore in practice the number of fluid flow connections needs to be kept to a minimum. The use of long run roofing sheets may increase the area of each device without necessarily increasing the number of connections. For example, a manifold may be used at each end of the covered channels to manage fluid flow.

In a preferred embodiment the channel in the roofing material is formed by extrusion during manufacture of the roofing material.

A solar thermal collector may be formed by extrusion during manufacture of a roofing material made of (for example and without limitation) steel, aluminium or copper, all of which are used to form common roofing materials.

An advantage of this embodiment is that the channel of the solar heat collector is formed integrally with the roofing material. This may save on assembly costs as the collector is completed by addition of plumbing connections to each end of the channel. Further, there are no bonded joins or other potential weaknesses in the roof plus collector, which may reduce maintenance costs. Another advantage is that the exterior appearance of the roof may be unchanged thus adding to the aesthetic appeal of the roof including the collector.

Those skilled in the art will appreciate, however, that other forms of roofing material, for example tiles, may be used and that reference to roofing material configured as preformed long run metal sheets only throughout this specification should not be seen as limiting.

Tiles made from a metallic base are another common form of roofing material. An energy conversion device can be constructed from such tiles. However, each tile may require plumbing connection to the rest of the system. The additional cost of installation and maintenance of a tile based system, due to the large increase in plumbing connections, makes it less viable from a financial viewpoint, although there may be other reasons for choosing to use tiles, for example to complement the appearance of the rest of a tiled roof.

Preferably the roofing material is made from a material having good thermal conductivity as this enhances the performance of a solar heat collector. Examples of such materials include steel, copper and aluminium, all of which are used as common roofing materials.

Not only do these materials have good thermal conductivity but may also provide other advantages, such as the ability to bond to other materials, including other steel, copper or aluminium substrates respectively.

Furthermore, roofing material made from these materials may be malleable and can be formed into complex shapes, on the site if necessary.

Preferably the roofing material is made from long run steel such as COLORSTEEL™, as this is cost effective and is commonly used for roofing in many countries, including New Zealand.

Those skilled in the art will however appreciate that other metals, such as aluminium or copper, may be used and that reference to roofing material made from long run steel only throughout this specification should not be seen as limiting.

In another preferred embodiment the roofing material is configured to include a substantially planar section. An advantage of a planar section is that it provides a flat surface onto which a panel may be bonded as required by some embodiments of the present invention. Bonding a panel to a flat surface may be easier than bonding a panel to a curved surface.

In a preferred embodiment the roofing material is configured as a standing seam roof. Standing seam roofs are a common form of long run roofing. They are formed from flat sheets of metal, commonly steel or aluminium, which may be cut or otherwise formed so as to extend from a ridgeline of a roof to the outer edge of the eaves. The longitudinal edges of the sheet are configured to form a ridge on either side of the sheet, such that neighbouring sheets can be overlapped, folded and sealed, forming a seam along the ridge. In typical installations the width of the substantially planar section between adjacent ridges is 5 cm-60 cm; however this should not be seen as limiting.

The substantially flat planar section formed between adjacent ridges is a preferred platform for the configuration of the present invention.

In another embodiment the roofing material is configured as a trough sheet roof. A trough sheet roof is formed from sheet materials configured as substantially parallel crests with substantially planar troughs between adjacent crests. The sheet materials are placed on the roof such that the troughs are aligned along the fall line of the roof.

In one simple embodiment of the present invention an open channel in the roofing material may be the space between adjacent protrusions on the surface of the roofing material. This could be the space between adjacent ridges in a standing seam roof or between adjacent crests in a trough sheet roof.

A covered channel in the roofing material according to the present invention is configured such that a ratio of the cross sectional area of the channel to the length of a perimeter of the cross section of the channel is less than 8 mm. This ratio is one quarter of the hydraulic diameter of the channel, this being a measure known to those skilled in the art.

Reference to a hydraulic diameter throughout this specification should be understood to refer to a measure commonly used by those skilled in the art as a parameter used in fluid mechanics when describing or comparing flow through channels having different cross sections. As is well known by those skilled in the art, the hydraulic diameter of a channel (tube or duct) is conveniently defined to be four times the cross-sectional area of the channel divided by the wetted perimeter of the channel. In all embodiments of the present invention the covered channel of the solar heat collector, in use, is intended to be filled with heat transfer fluid, so that the wetted perimeter is taken to be the same as the perimeter of the cross section of the covered channel.

The hydraulic diameter represents the characteristic length that defines the size of a cross section for a specified shape. In particular it is commonly used as a convenient parameter for non circular channels; it is less commonly referred to for circular channels as the hydraulic diameter of a circular channel is equal to the diameter of the channel.

The solar collector of the present invention has a channel which may be of any convenient cross section, provided that the hydraulic diameter is less than 32 mm (i.e. the ratio of the area of a cross section of the covered channel to the perimeter of the covered channel is less than 8 mm.).

The inventors have found that use of a hydraulic diameter greater than 32 mm may lead to potential problems with stress related buckling of the roofing material as may occur for channels having a hydraulic diameter greater than 32 mm when filled with fluid.

In a preferred embodiment the hydraulic diameter of the channel is less than 20 mm (i.e. the ratio is less than 5 mm).

The applicant has found that a roof structure including an energy conversion device according to the present invention having a channel with a hydraulic diameter larger than about 20 mm may lead to structural problems. In particular the weight of fluid required to substantially fill such a channel may create a stress greater than the roofing material and normal structural support are able to support without deformation and potentially weakening or failure of the roofing material and/or structural support of the roof.

A channel having a hydraulic diameter less than 20 mm may provide a further advantage in a smaller and less expensive pump may be used to move the heat transfer fluid through the channel in comparison with channels having a hydraulic diameter greater than 20 mm.

In a preferred embodiment the hydraulic diameter of the channel is in the range from 6 mm to 10 mm (i.e. the ratio is in the range 1.5 mm to 2.5 mm).

The applicant has found that a covered channel having a hydraulic diameter in the range from about 6 mm to about 10 mm provides an energy conversion device that is practical, being relatively easy to form, and which can be accommodated by standard roofing materials. Such an energy conversion device may be used with normal support structures for such roofs and the stress in the roofing material due to the heat exchange fluid in such a channel under normal operating pressures may be safely below the failure stress of the material.

In a particularly preferred embodiment the hydraulic diameter of the channel is about 8 mm (i.e. ratio about 2 mm).

This corresponds to a channel having a circular cross section of diameter 8 mm or a rectangular cross section having a depth around 4 mm and a width greater than around 20 mm. The applicant has found that such channels are relatively easy to form and provide good thermal transfer from the cover of the channel to the heat transfer fluid.

Use of a channel having an hydraulic diameter of about 8 mm may reduce plumbing cost as the size of the fittings may be reduced.

In a preferred embodiment the cross section of the channel is circular. As mentioned above, for a circular channel the hydraulic diameter of the channel is equal to the diameter of the circular cross section.

A circular cross section channel may be formed during manufacture of a section of roofing material, for example by extrusion. In some embodiments a channel having a circular cross section may be formed so that the channel is substantially above the usual line of the roofing material. This arrangement may increase the surface area of the roofing material around the channel that is exposed to solar radiation, thus potentially increasing the efficiency of the solar collector.

An advantage of a circular cross section channel is that it may be connected to standard hose fittings, which may reduce plumbing costs.

In some other preferred embodiments the cross section of the channel is rectangular, as this is reasonably simple to form (either into the roofing material or into a plate to be bonded to the roofing material) although many other shapes, such as (without limitation) circular, trapezoidal, triangular, or oval shaped, may be used.

The hydraulic diameter of a channel having a rectangular cross section of width W and depth D, in which W is substantially greater than D, is approximately 2 times D.

The applicants envisage that in some embodiments a panel may include a covered channel configured such that the hydraulic ration is less than 32 mm. In such embodiments the panel forms the energy conversion device, the roofing material providing a substrate for the panel.

Embodiments formed in this manner may be particularly advantageous when retrofitting a solar thermal collector to an existing roof. An advantage of such embodiments is that the panel may be formed as a stand-alone unit. The covered channels may be easier to form in a stand-alone panel than during manufacture of the roofing material, thus reducing costs.

In some other embodiments of the present invention a panel may be bonded to a roofing material to form a covered channel through which fluid can flow. A panel can be used to create a covered channel by forming a cover over an open channel formed in the roofing material, by the roofing material forming a base to an open channel formed in the panel, or by a combination of both the above.

Reference to bonding two articles throughout this specification should be interpreted broadly to refer to situations in which the two articles are held together in a fixed relationship, by whatever means. A bond may be formed (for example and without limitation) by use of an adhesive, a weld, a fastener (nut and bolt etc), a snap fit or other such method of holding two articles together as is well known by those skilled in the art.

In a simple embodiment a panel may be bonded to adjacent protrusions on the surface of the roofing material to create a covered channel. In this manner a basic solar thermal collector may be formed, using the high thermal conductivity of the panel and roofing material to provide an effective thermal absorber.

In practice, however, a solar thermal collector formed as above may have low thermal efficiency, as well as being impractical. The heat transfer from the panel to the liquid is likely to be poor due to the small ratio of the contact area of the cover to the volume of heat transfer liquid in the channel.

In one preferred embodiment one or more open channels are formed in the substantially planar section of the roofing material. The open channel may be formed by a process of folding, rolling or by using a press. However, any method that deforms the metal surface to form an open channel can be used, and reference to folding, rolling or pressing only in this specification should not be seen as limiting.

In other embodiments an open channel may be formed in a curved section of the roofing material. However, bonding a panel to a curved surface is generally more difficult than bonding it to a planar surface. Such embodiments are therefore likely to be more expensive as typically some form of intermediary substrate, which has a planar surface for bonding to the panel and a curved surface to match the curve of the roofing material, may be required.

In one preferred embodiment a single open channel is formed in the substantially planar section of the roofing material.

An advantage of a single open channel is that it may be formed simply and at low cost in comparison with the formation of multiple channels.

However, in alternate embodiments a plurality of channels may be formed in the substantially planar section of the roofing material. Such an arrangement may be an advantage for spreading the load of the collector across a wider section of the roofing material, which may reduce any tendency towards buckling of the roofing material.

In a preferred embodiment the cross section of an open channel is rectangular. A rectangular channel may be readily formed in long run metal roofing materials by folding, rolling or pressing. However, any convenient shape may be used, provided that the width of the channel is substantially greater than the depth.

In a preferred embodiment the open channel is formed during production of the roofing material. Integrating the manufacture of the open channel(s) with the roof product increases the value of the roofing product by adding multiple features in the same or similar forming process.

It may be less expensive to form an open channel in the surface of a sheet of metal than it is to form a covered channel. The cost may be further reduced if an open channel is formed as an integral part of forming a roofing material.

In a preferred embodiment the open channel extends substantially the length of a roofing panel.

The open channel(s) may be straight or formed into a pattern. For example the open channel may form an open loop extending over substantially the length of the roof panel with the open ends of the loop at the same end of the panel.

An energy conversion device according to this embodiment of the present invention is formed by covering the open channel in a roofing material by directly or indirectly bonding at least one panel to the roofing material so as to form a covered channel.

Reference to bonding a panel directly or indirectly to a roofing material throughout this specification should be understood to refer to situations where at least part of the panel is in intimate contact with the roofing material (direct bonding) or where part of the panel is bonded directly to an intermediary substrate which in turn is bonded directly to the roofing material.

In a preferred embodiment the panel is a sheet of heat conducting material.

A panel in the form of a sheet of heat conducting material will be referred to as a convection plate. One function of a convection plate is to act as a collector for a solar thermal collector.

A convection plate according to the present invention is configured to form bonded joins with a long run roofing panel having one or more open channels so as to form a covered channel through which fluid can flow.

In preferred embodiments the convection plate is formed from the same material as the roofing material. In this way the thermal conductivity of the roofing material and convection plate are the same, which may reduce or eliminate stress between the bonded panel and roofing material due to mismatch of thermal expansion during changes of temperature.

In some alternate embodiments of the energy conversion device the covered channel is formed by bonding (directly or indirectly) a panel onto a roofing material, wherein the panel is configured to include one or more open channels. In such embodiments there may be advantage in using a convection plate for the panel.

An advantage of the above embodiment is that it may be possible to retrofit an energy conversion device according to the present invention to an existing roof. The embodiments discussed above are created by forming open channels in the roofing material during manufacture, either by extrusion or other means, the open channels subsequently being covered by a panel. These embodiments are primarily designed for use with new roofs, although retrofitting may be possible through removal of a section of existing roof and replacement with a section of new roofing material including the solar thermal collector. However, this option may be more expensive than that of bonding a convection plate (including open or closed channels) onto a section of existing roofing material.

The dimensions of the covered channel(s) are a key factor in the efficient and effective production of a solar heat collector according to all embodiments of the present invention. In particular the hydraulic diameter of the covered channel is restricted to be less than 32 mm.

Reference to a width (W) of a rectangular channel being substantially greater than a depth (D) throughout this specification should be understood to mean that D/W is substantially less than 1. For practical purposes this equates to a width being typically a minimum of 5 times the depth. For covered channels having a rectangular cross section in which the width is greater than 5 times the depth, the restriction on the hydraulic diameter in the present invention typically equates to using a wide rectangular channel having a depth less than 16 mm.

A key advantage of using a rectangular channel having a width substantially greater than the depth is that this may increase the efficiency of the solar heat collector by exposing a large portion of the heat transfer fluid in the channel to the heated cover of the channel (ie the cover of the channel that is exposed to sunlight).

In a preferred embodiment the width of the channel is less than 50 mm.

The applicant has found that a channel having a depth of around 2 mm (which is close to the practical lower limit for depth of a channel) when filled with heat transfer fluid may lead to significant buckling of the roofing material when the width of the channel exceeds around 50 mm (for a typical roofing material having a thickness of about 0.5 mm). Thus additional bracing support would be required to support the roofing material for channels of width greater than 50 mm, which, in use, adds to the cost of the installation as well as adding unwanted weight and load to the structure supporting the roofing material. A rectangular channel having a width substantially greater than its depth, and a depth of around 2 mm, has a hydraulic diameter of around twice the depth—in this instance around 4 mm.

The present invention provides a solar thermal collector that utilises common roofing material. This arrangement has the advantage of providing a solar thermal collector without the requirement for a separate frame or other support structure. By utilising common roofing material the device may be readily incorporated into a building without major reconstruction or changes to the appearance of the building.

In a preferred embodiment the energy conversion device includes an entrapped air gap above the energy conversion device.

In a preferred embodiment the air gap is formed by a sheet of transparent material located in a plane above and substantially parallel to the surface of the roofing material (for an extruded channel) or the plane of the convection plate (where used). The edges of the transparent material are sealed to the roofing material to reduce heat losses due to convection.

Solar heating of the entrapped air is used to raise the temperature of the energy conversion device through the greenhouse effect. The increased temperature increases the quantity of heat transferred to the fluid in the channels (for an equivalent flow rate), improving the efficiency of the solar thermal collector.

Preferably the transparent material is glass or UV stabilised polycarbonate.

In an alternate embodiment a honeycomb module material provides the entrapped air gap. A honeycomb module may be any structure that is configured to retain or entrap air in cells.

In a preferred embodiment a layer of insulating material is bonded to the surface of the roofing material opposite that containing the channels (the lower surface). Insulating the lower surface of the roofing material improves the efficiency of the solar thermal collector by limiting heat loss through the roof. It may also reduce heat loading from the roofing material to the inside of the structure during hot periods, such as during summer.

The energy conversion system described above provides many significant advantages over conventional systems for solar thermal collection, particularly when the energy conversion system is integrated into the roof of a structure.

With the present energy conversion system the solar thermal collector may be installed as part of the normal installation of the roof, rather than as separate installations (roof and solar thermal collector). Furthermore, by appropriate arrangement of the plumbing connections to the energy conversion system it can be readily connected to the plumbing circuits of the building without the need for further extensive plumbing work.

In practice it is envisaged that the energy conversion system will be installed by a suitably qualified person who will install the roofing material incorporating the solar thermal collector, and make all the necessary connections at the same time, saving time and expense.

Incorporating the solar thermal collector into the common roofing material as an integral part of the system removes the need for a separate structure to support it. The result may be a significant reduction (over conventional arrangements) in the amount of material used and therefore the additional weight loading on the structure. There is also a significant cost saving over conventional devices in the use of fewer materials and the reduction of labour costs required for construction and installation of support structures.

The manner of forming the solar thermal collector does not interfere with the integrity of the roofing material, and reduces any additional risk of leakage or other failure due to the fixtures required to attach the mounting for a conventional solar thermal collector.

A further advantage of the present invention is that it may be standardised and approved for installation as a product integrated into the roof. This may result in the installation being carried out without the requirement for separate inspection and approval by an engineer, thus saving compliance costs.

The present energy conversion device, being formed as part of the normal roofing structure, may blend in with the roofline, resulting in a more acceptable appearance than may be the case with conventional solar thermal collectors mounted on frames above the roof. It may also reduce the additional wind loading experienced with conventional installations.

The total cost of the integrated energy conversion system may also be lower than the sum of the separate costs for roofing and a solar thermal collector, there being no need for separate support structures or additional strengthening of the framework of the building.

In other embodiments it is envisaged that the present invention may provide a relatively simple, cost effective and efficient stand alone solar thermal collector. It may be relatively simple to form and cost effective as it uses simple manufacturing techniques to produce channels through which heat transfer liquid can flow. Further, there may be savings in cost and accessibility of materials, as roofing materials are commonly mass produced and readily available in most areas.

### BRIEF DESCRIPTION OF DRAWINGS

Further aspects of the present invention will become apparent from the following description which is given by way of example only and with reference to the accompanying drawings in which:

FIG. 1 shows a cross-section view of an energy conversion device according to one embodiment of the present invention;

FIG. 2 (a) shows a cross-section view of an energy conversion device according to another embodiment of the present invention;

FIG. 2 (b) shows a cross-section view of an energy conversion device according to another embodiment of the present invention;

FIG. 3 shows a cross-section view of part of an energy conversion device according to another embodiment of the present invention;

FIG. 4 shows a cross-section view of another embodiment of an energy conversion device including the part of FIG. 3;

FIG. 5 shows a cross-section view of another embodiment of an energy conversion device including the part of FIG. 3;

FIG. 6 shows a cross-section view of an energy conversion device according to another embodiment of the present invention;

FIG. 7 shows a cross-section view an energy conversion device according to another embodiment of the present invention;

FIG. 8 shows a cross-section view of an energy conversion device according to another embodiment of the present invention; and

FIG. 9 shows a cross-section view of an energy conversion device according to another embodiment of the present invention.

### BEST MODES FOR CARRYING OUT THE INVENTION

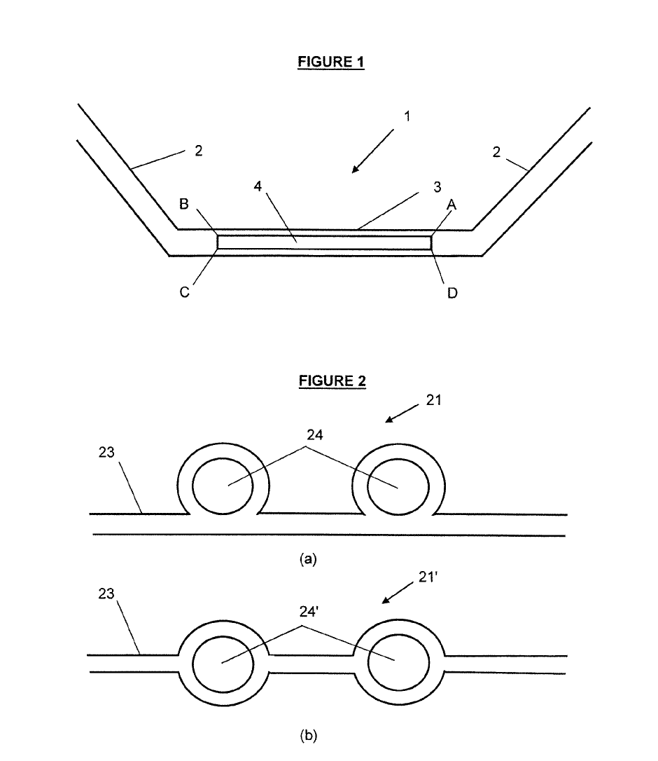

FIG. 1 shows a cross-section view of an energy conversion device, generally indicated by arrow 1, according to one embodiment of the present invention.

A standard roofing material, generally indicated by (2, 3), in the form of a long run COLOURSTEEL™ panel, is in the form of a standing seam roof. The standing seam roof includes ridges (2) and a planar section (3) between adjacent ridges (2). (The Figures are schematic illustrations and are not intended to be indicative of scale.)

The energy conversion device (1) includes a covered channel (4) formed within the planar section (3) of the roofing material (2, 3). The covered channel has a rectangular cross section in which the width (AB) is substantially greater than the depth (AD). The dimension of the covered channel are such that the ratio of the area of the covered channel (AB×AD) to the perimeter (2×(AB+AD)), is less than 8 mm. An energy conversion device illustrated in FIG. 1 may be formed by extrusion during production of the roofing material (2, 3).

FIG. 2 shows a cross section through an energy conversion device according to another embodiment in which the covered channel (24, 24′) is formed within the planar section (23) of the roofing material. In the embodiment (21) shown in FIG. 2 (a) the channel has a circular cross section with the channel substantially above the line of the roofing material (23). This arrangement may provide increased efficiency by having a significant part of the perimeter of the channel potentially exposed to solar radiation. In the embodiment (21′) shown in FIG. 2 (b) the covered channel (24′) is also circular in cross section, although in this embodiment the channels are centred in the same plane as the planar section (23) of roofing material.

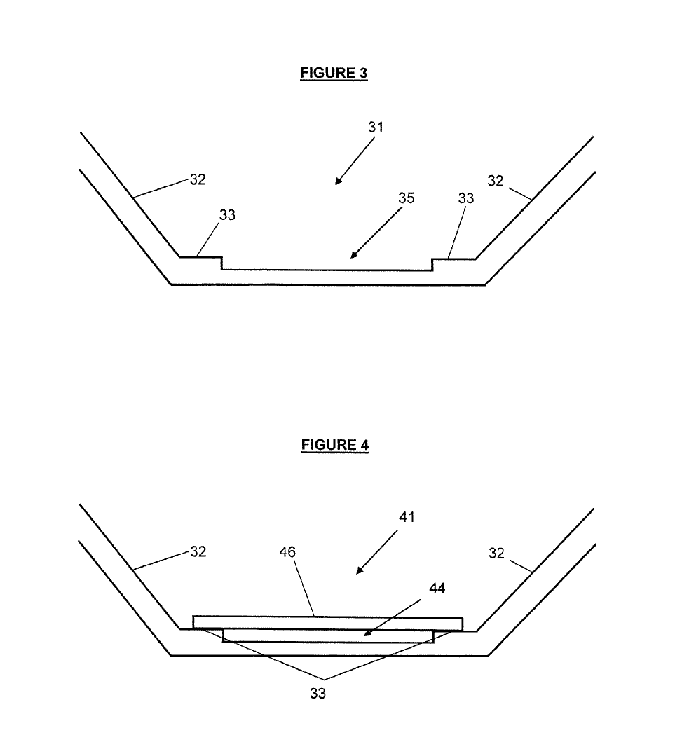

In another embodiment of an energy conversion device an open channel (35) is formed in the planar section (33) of a roofing material (32, 33) during production of a long run COLOURSTEEL™ standing seam roofing material, as shown in a cross-section view in FIG. 3. The open channel (35) may be formed by rolling, pressing or any other suitable production method.

The open channel (35) is covered by bonding a panel, in the form of a convection plate (46) made of long run COLOURSTEEL™, to the roofing material (32, 33) at the surface (33) of the roofing material (32, 33). The bonding of the convection plate (46) to the roofing material (33) over the open channel (35) is such as to form a rectangular covered channel (44) through which heat transfer fluid (not shown) can flow, as illustrated in FIG. 4.

FIG. 5 shows another embodiment (51) based on use of an open channel (55) formed in the roofing material (53) as shown in FIG. 3. In this embodiment a covered channel (54) is formed in a panel, in the form of a convection plate (56) made of long run COLOURSTEEL™, which is then inserted into the open channel (55) in the roofing material (53). The panel (56) and open channel (55) are configured such that the panel (56) can “snap fit” into the open channel (55) in the roofing material (53). In alternate embodiments the panel (56) is bonded to the roofing material (53).

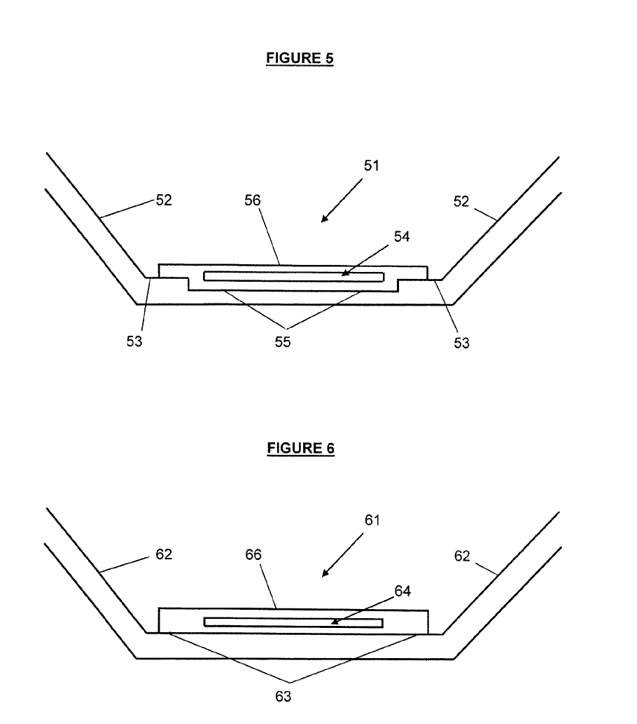

In the embodiment (61) illustrated in FIG. 6 a covered channel (4) is formed in a panel, in the form of a convection plate (66) made of long run COLOURSTEEL™, which is then bonded onto the planar section of the roofing material (63). This embodiment is useful for retrofitting to existing roofs as it does not require modification of the roofing material.

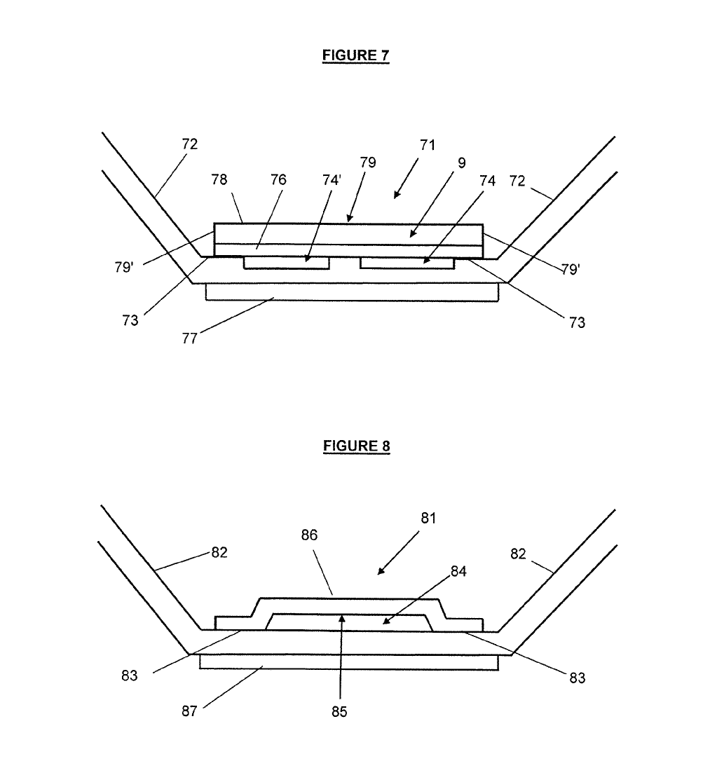

FIG. 7 shows a cross-sectional view of an energy conversion device (71) as described above including a volume of entrapped air (9). An enclosure (79) is formed above the panel (76) by a sheet of transparent material in the form of a sheet of UV stabilised polycarbonate (78) located in a plane above and substantially parallel to the plane of the panel (6)/roofing material (3). The sheet of UV stabilised polycarbonate (78) is sealed to the roofing material (72, 73) by sealing to the enclosure sides (79′) which are sealed to the roofing material (72, 73). In alternate embodiments the sheet of UV stabilised polycarbonate is sealed to adjacent crests of the roofing material so as to span the intervening trough.

The energy conversion device shown in FIG. 7 includes two covered channels (74, 74′) through which heat transfer fluid can flow.

The energy conversion device shown in FIG. 7 includes an insulating layer (77) attached to the side of the roofing material (72, 73) opposite the surface (73) to which the convection plate (76) is bonded. The use of an insulating layer (77) in this way enhances the efficiency of the solar collector by preventing heat loss from the underside of the roofing material (72, 73). Conversely this provides the further advantage of reducing the heating load into the building due to heat transfer through the roof.

Another embodiment (81) of an energy conversion device (shown in cross section in FIG. 8) includes a convection plate (86) configured to form an open channel (85). A covered channel (84) is formed by bonding the convection plate (86) to the planar surface (83) of a standard roofing material (82, 83). The channel (84) illustrated in FIG. 8 has a trapezoidal cross section in which the width is substantially greater than the depth, and the hydraulic diameter is less than 32 mm.

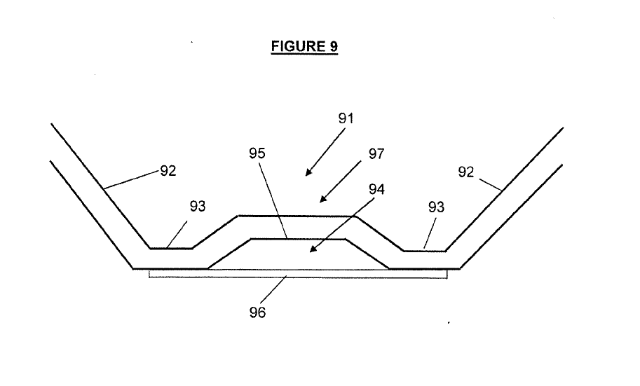

Yet another embodiment (91) of an energy conversion device (shown in cross section in FIG. 9) includes an open channel (95) formed in the planar section of the roofing material (93) by configuring the roofing material into a ridge (97). A closed channel (94) is formed by closing off the open channel with a plate 96 bonded to the lower surface of the roofing material (93). In other embodiments (not shown) a panel including a closed channel may be bonded into the open channel (95) under the ridge (97).

In all embodiments a manifold may be used to connect the energy conversion device to a circuit through which heat transfer fluid flow may flow. The circuit may include a heat exchanger and a pump.

In use the energy conversion device forms part of a roof structure. When exposed to the sun solar energy heats the convection plate (46, 56, 66, 76, 86) (or the roofing material (3) in the embodiments shown in FIGS. 1 and 9), which in turn heats the heat transfer fluid flowing within the channel (4, 24, 44, 54, 64, 74, 84 and 94). This heat may be recovered subsequently, for example by passing the heated heat transfer fluid through a heat exchanger (not shown), or any other suitable arrangement as is well known in the art.

Aspects of the present invention have been described by way of example only and it should be appreciated that modifications and additions may be made thereto without departing from the scope thereof.

1. An energy conversion device, comprising:
a roofing material;
the roofing material includes a covered channel through which fluid can flow, the channel configured such that a ratio of the cross sectional area of the channel to the length of a perimeter of the cross section of the channel is less than 8 mm.

2. An energy conversion device, comprising:
a roofing material configured to accept a panel;
at least one panel configured to include at least one covered channel through which fluid can flow;
wherein the panel is bonded directly or indirectly to the roofing material; and
the covered channel is configured such that a ratio of the cross sectional area of the covered channel to the length of a perimeter of the cross section of the covered channel is less than 8 mm.

3. An energy conversion device, comprising:
a roofing material configured to accept a panel;
at least one panel configured to include at least one open channel;
wherein the panel is bonded directly or indirectly to the roofing material so as to form a covered channel through which fluid can flow; and
the covered channel is configured such that a ratio of the cross sectional area of the covered channel to the length of a perimeter of the cross section of the covered channel is less than 8 mm.

4. The energy conversion device as claimed in claim 1 wherein the ratio has a value less than 5 mm.

5. The energy conversion device as claimed in claim 1 wherein the ratio has a value within the range 1.5 mm to 2.5 mm.

6. An energy conversion device, comprising:
a roofing material configured to include one or more open channels; and
at least one panel;
wherein the panel is bonded directly or indirectly to the roofing material so as to form a covered channel through which fluid can flow; and
a largest dimension of the covered channel cross-section is closest to the panel.

7. The energy conversion device as claimed in claim 1 wherein the roofing material is a long run metal panel.

8. The energy conversion device as claimed in claim 1 wherein the roofing material is configured to include a substantially planar section.

9. The energy conversion device as claimed in claim 1 wherein the roofing material is configured as a standing seam roof.

10. The energy conversion device as claimed in claim 1 wherein the roofing material is configured as a trough sheet roof.

11. The energy conversion device as claimed in claim 1 wherein the cross section of the covered channel is circular.

12. The energy conversion device as claimed in claim 1 wherein the cross section of the covered channel is rectangular.

13. The energy conversion device as claimed in claim 1 wherein the panel is formed from the same material as the roofing material.

14. The energy conversion device as claimed in claim 1 wherein the channel in the roofing material is formed by extrusion.

15. The energy conversion device as claimed in claim 1 including an entrapped air gap.

16. The energy conversion device as claimed in claim 15 wherein the air gap is formed by a sheet of transparent material located in a plane above and substantially parallel to the surface of the roofing material.

17. The energy conversion device as claimed in claim 1 wherein a layer of insulating material is bonded to the lower surface of the roofing material.

18. A method of construction of an energy conversion device including a roofing material, comprising:
a) forming a covered channel in the roofing material,
wherein a ratio of the cross sectional area of the covered channel to the length of a perimeter of the cross section of the covered channel is less than 8 mm.

19. A method of construction of an energy conversion device including a roofing material configured to accept a panel; and at least one panel configured to include a covered channel, wherein a ratio of the cross sectional area of the covered channel to the length of a perimeter of the cross section of the covered channel is less than 8 mm,
the method comprising:
bonding the panel directly or indirectly onto the roofing material.

20. A method of construction of an energy conversion device including a roofing material configured to accept a panel; and at least one panel configured to include an open channel,
the method comprising:
bonding the panel directly or indirectly onto the roofing material to form a covered channel wherein a ratio of the cross sectional area of the covered channel to the length of a perimeter of the cross section of the covered channel is less than 8 mm.

21. (canceled)
